(19) United States
(12) Patent Application Publication
(10) Pub. No.: US 2020/0032398 A1
(43) Pub. Date: Jan. 30, 2020

(54) SURFACE TREATMENT PLANT, PRECONDITIONING APPARATUS AND PROCESS FOR TREATING PROCESS MEDIUM AND/OR RINSING MEDIUM

(71) Applicant: EISENMANN SE, Böblingen (DE)

(72) Inventors: Georg Fröhlich, Oberderdingen (DE); Jennifer Schulze, Herrenberg (DE)

(21) Appl. No.: 16/520,683

(22) Filed: Jul. 24, 2019

(30) Foreign Application Priority Data
Jul. 26, 2018 (DE) 10 2018 118 089.6
Nov. 30, 2018 (DE) 10 2018 130 593.1

(51) Int. Cl. C23C 22/73; C23C 22/82; C23C 22/34; C23C 22/78; B01J 41/02; B01J 47/028

(52) U.S. Cl. CPC C23C 22/73; C23C 22/82; B01J 47/028; C23C 22/78; B01J 41/02; C23C 22/34

(57) ABSTRACT

A surface treatment plant for treating objects, in particular vehicle bodies, has a thin film conversion process in which a ceramic thin film is applied to the objects using a process medium, a subsequent rinsing step in which the objects are rinsed with rinsing medium after the thin film conversion process, and a deionization plant which has a cation exchanger and a downstream anion exchanger and is configured for deionizing the process medium and/or the rinsing medium. For economical operation, the deionization plant is preceded by a preconditioning apparatus which is configured for removing complex anions which are formed and/or present in the thin film conversion process from the process medium and/or the rinsing medium. Furthermore, a corresponding preconditioning apparatus and a treatment process are described.

### RELATED APPLICATIONS

The present application claims priority to German Application No. 10 2018 118 089.6 filed Jul. 26, 2018 and German Application No. 10 2018 130 593.1 filed Nov. 30, 2018—the contents of both of which are fully incorporated herein by reference.

### BACKGROUND OF THE INVENTION

### 1. Field of the Invention

The invention relates to a surface treatment plant for treating objects, in particular vehicle bodies, comprising
a) a thin film conversion process in which a ceramic thin film is applied to the objects using a process medium,
b) a subsequent rinsing step in which the objects are rinsed with rinsing medium after the thin film conversion process, and
c) a deionization plant which
   comprises a cation exchanger and a downstream anion exchanger and
   is configured for deionizing the process medium and/or the rinsing medium.

The invention further relates to a preconditioning apparatus and also a process for treating process medium and/or rinsing medium in the surface treatment of objects.

### 2. Description of the Prior Art

Metallic materials have to be protected against damaging corrosion. For this reason, the metal surface of objects is usually covered with protective coatings in surface treatment plants. Surface coatings which form a closed film composed of organic polymers have been found to be useful for this purpose.

For the surface coating to be able to perform its protective function, good adhesion to the material is important. To ensure reliable adhesion of the surface coating, the metallic materials have to be pretreated before surface coating.

The pretreatment before surface coating usually comprises cleaning processes for removing dirt and/or pickling processes for removing, for example, adhering rust or layers of scale and also, in particular, a conversion process for applying a bonding layer to the workpiece surface.

For a summary of the processes used in the pretreatment, reference may be made to the as yet unpublished DE 10 2018 115 289 by the applicant.

Phosphating has for decades been used as preferred conversion process. Here, a conversion layer composed of metal phosphates is formed on the workpiece surface by application of appropriate chemicals. Because of its structured surface, this phosphate layer provides good adhesion for the subsequent layers of surface coating. The corrosion protection properties of a workpiece having a phosphate layer and subsequent surface coating layers are many times better than without such a phosphate layer.

In industrial surface treatment plants, wet-chemical pretreatment has been found to be useful. There, the cleaning process, the pickling process and/or the conversion process are carried out in a plurality of successive treatment zones. The objects to be treated are transported by means of a transport system through the zones and there brought into contact with the respective aqueous process media.

Contacting is usually effected by spraying or flooding with the process medium or by dipping the object into a process bath or combinations thereof. Regardless of the process procedure selected, which is specifically designed for each particular case, residues of the process medium remain on the surface of the object after contacting of the object with the process medium. These residues are carried out into the subsequent treatment zone or even into a plurality of subsequent treatment zones, as a result of which these/this becomes or become increasingly contaminated.

The contamination can have adverse effects on the treatment process in this subsequent treatment zone.

To minimize damaging effects of this entrainment on subsequent treatment zones, the cleaning zones, the pickling zones and the conversion zones are followed by additional rinsing zones. In the rinsing zones, the objects are rinsed with process water and/or deionized water (DI water), as a result of which the residues of the process medium are taken up in the rinsing water. The impurities which accumulate in the rinsing water can be removed by continuous or intermittent discharge as wastewater and diluted by introduction of fresh water.

A further possible way of removing interfering impurities from rinsing water or else from other process liquids of the pretreatment is the use of bath care measures. Impurities are in this case separated off by means of technical separation methods, which makes longer use of the process medium and/or the rinsing medium possible. The consumption of process medium, the fresh water consumption and/or the incidence of wastewater can be reduced in this way.

One frequently utilized bath care measure is the use of ion exchangers (IE). Ions which are present in dissolved form in water can be removed by means of this technology. In the pretreatment, it is prior art to purify the last rinsing zones, i.e. the rinsing water, by means of ion exchangers after phosphating has been employed as conversion process. Here, the rinsing water to be purified is firstly conveyed through a filter, usually a gravel filter, in order to remove relatively coarse particles, for example iron hydroxide sludges. The rinsing water subsequently flows through a cation exchanger (CE) in which there is a solids bed made up of specific particles which are able to replace positively charged ions in the process water by hydrogen ions (H⁺ ions).

The rinsing water subsequently flows through an anion exchanger (AE) in which negatively charged ions are replaced in a similar way by hydroxide ions (OH⁻ ions).

The hydrogen ions and the hydroxide ions neutralize one another to form normal water (H₂O), so that virtually ion-free water leaves the total ion exchanger.

The purified rinsing water can subsequently be recirculated to the rinsing zones and thus be utilized again. When an ion exchanger is exhausted because it has reached its uptake capacity for contaminant ions, it has to be regenerated. For this purpose, the cation exchanger is usually regenerated by means of an acidic hydrochloric acid solution (HCl) and the anion exchanger is regenerated by means of an alkaline sodium hydroxide solution (NaOH).

However, in recent years phosphating as established conversion process in pretreatment has been replaced by alternative processes based on zirconium, titanium and/or silicon compounds. In this “thin film conversion”, a nanosize ceramic conversion layer is produced on the surface of the object by action of chemicals. The term nanoceramic is therefore also used. The conversion layer formed then consists mainly of oxidic compounds (e.g. ZrO₂, TiO₂, SiO₂).

However, the thin film conversion process based on zirconium, titanium and/or silicon compounds is not only used for completely replacing phosphating but can also be used to supplement classical phosphating. In this case, the thin film conversion process is frequently also referred to as after-rinsing solution or passivation. Especially in the surface treatment of vehicle bodies, where demanding quality requirements have to be met, phosphating is frequently firstly followed by rinsing, then a thin film conversion referred to as passivation and then rinsing again. It is assumed that, as a result of the passivation, free metal surfaces which have not been satisfactorily phosphated are passivated by the thin film conversion and the corrosion protection is increased thereby. The chemical compositions of the thin film conversion process replacing phosphating and the thin film conversion process supplementing phosphating are very largely similar.

### SUMMARY OF THE INVENTION

The invention now addresses the problem of providing a surface treatment plant for the thin film conversion treatment, which additionally allows the treatment of process medium and/or rinsing medium.

This may be achieved according to the invention by a surface treatment plant of the type described at the outset, wherein
d) a preconditioning apparatus which is configured for removing complex anions which are formed and/or present in the thin film conversion process from the process medium and/or the rinsing medium is located upstream of the deionization plant.

The inventors have recognized that the previous arrangement of gravel filter, cation exchanger and anion exchanger in series in a deionization plant for treating process medium and/or rinsing medium is no longer possible without problems. This is because when the known techniques are used, precipitation of solids occurs in the deionization plant and causes blocking of the ion exchangers after only a few operating cycles. This is associated with an increase in the hydrodynamic pressure drop and a decrease in the ion exchange capacity.

The inventors have also recognized that the undesirable precipitation of solids in the deionization plant occurs especially in the treatment of rinsing medium when dissolved zirconium, titanium and/or silicon compounds which come from the thin film conversion process are present in the rinsing medium.

Furthermore, the inventors have recognized that the regular regeneration of the anion exchanger in the deionization plant by means of a sodium hydroxide solution represented the trigger for precipitation of solids. Analyses have then shown that the precipitated solids comprised (hydr)oxidic compounds of zirconium, titanium and/or silicon which are sparingly soluble in water and/or in acid.

It has been recognized that the compounds of zirconium (Zr), titanium (Ti) and silicon (Si) used in the thin film conversion process, for example hexafluorozirconic acid (H₂ZrF₆), hexafluorotitanic acid (H₂TiF₆), hexafluorosilicic acid (H₂SiF₆) and/or their readily soluble alkali metal salts, ammonium salts and/or thin film conversion solutions in the form of (organo)silanes are present as water-soluble complex ions in the process medium and/or rinsing medium. For example, these are [ZrF₆]²⁻ ions, [TiF₆]²⁻ ions and/or [SiF₆]²⁻ ions. However, the stability of the complex ions is dependent on the pH of the solution, as a result of which the sparingly soluble hydroxides, oxides and/or oxyhydroxides precipitate as solid in the regeneration of the anion exchanger by means of sodium hydroxide in the deionization plant.

According to the invention, the inventors therefore propose providing a preconditioning apparatus which removes the complex anions from the process medium and/or the rinsing medium before these go into the deionization plant. This further enables a conventional DI water plant according to the prior art to serve as deionization plant. The main purpose thereof can be to produce DI water from process water or fresh water. The preconditioning apparatus effectively also allows process medium and/or rinsing medium to be used.

For the purposes of the invention, removal of the complex anions means removal of the complex anions to at least such an extent that the deionization plant can be operated economically.

The preconditioning apparatus preferably has an anion exchanger which is configured for replacing the complex anions by other anions.

As will be made more clear below, an anion exchanger as precondition apparatus is an economically feasible possibility for removing the interfering complex anions upstream of the deionization plant. These other anions, referred to as exchange ions, should in particular be those which present problems for the subsequent deionization plant neither in deionizing operation nor during regeneration, for example lead to blocking of the exchanger material. Ion exchange of the process medium and/or rinsing medium flowing through the preconditioning apparatus thus takes place in the preconditioning apparatus. In the ion exchange, the interfering complex anions are replaced by other salt anions (i.e. in particular not by OH⁻ ions) which do not cause problems in the subsequent DI water plant.

Acid anions such as phosphate (PO₄³⁻) and/or hydrogenphosphates (HPO₄²⁻ and H₂PO₄⁻) generally come into question as exchange anion. However, preference is given to acid anions of strong to middle-strength acids, for example the acid radicals of hydrochloric acid, nitric acid or sulfuric acid. For example, the acid anions can also be iodide (I⁻), bromide (Br⁻), fluoride (F⁻) and/or hydrogensulfate (HSO₄⁻). Replacement by chloride (Cl⁻), nitrate (NO₃⁻) or sulfate (SO₄²⁻) is therefore particularly advantageous.

An anion exchanger which has a weakly basic exchanger material which for the actual process is preferably loaded with chloride (Cl⁻) has been found to be particularly advantageous as preconditioning apparatus. The deionization plant can, in a customary way, also have firstly a cation exchanger with strongly acidic exchanger material and subsequently an anion exchanger with weakly basic exchanger material.

The acid anions leave the preconditioning apparatus together with the process medium and/or the rinsing medium.

The complex anions remain in the anion exchanger, so that this has to be regenerated from time to time. This is effected by means of a regenerating agent which contains the acid anion in concentrated form. The regenerate, which contains the regenerating agent and the complex anions, is discharged and/or collected. In the most favorable case, the complex anions can, for example, be separated off by means of a regeneration apparatus and recirculated to the thin film conversion process.

The anion exchanger of the preconditioning apparatus preferably comprises a selective exchanger material.

This enables the preconditioning apparatus to be designed only for replacement of the complex anions. Other anions which are unproblematical for the subsequent deionization plant can remain in the process medium and/or in the rinsing medium. This leads to reduced loading of the anion exchanger in the preconditioning apparatus.

The anion exchanger of the preconditioning apparatus is preferably regenerated using a regenerating agent which has a pH of less than about 6.

As a result of the anion exchanger of the preconditioning apparatus being regenerated under acidic conditions, the complex anions do not precipitate but instead are present in dissolved form in the regenerate. For this purpose, the regenerating agent should preferably comprise acid ions of strong acids. Acid ions of strong acids (for example hydrochloric acid HCl; nitric acid HNO₃ or sulfuric acid H₂SO₄) do not shift the pH, while acid ions of middle-strength or weak acids can increase the pH. Regenerating agents which contain the acid ion together with its corresponding acid are considered to be suitable. Thus, aqueous solutions of nitrate salt (e.g. sodium nitrate) with nitric acid or of sulfate salt (e.g. sodium sulfate) with sulfuric acid are suitable. An aqueous solution of a sodium chloride solution (NaCl) with hydrochloric acid (HCl) has been found to be particularly useful. As an alternative, it is of course also possible to use only HCl or only NaCl, i.e. only the acid or only the salt.

It is important that the pH of the anion exchanger in the preconditioning apparatus is not increased during the regeneration, since precipitation of solids would otherwise occur.

After regeneration, the apparatus is preferably flushed with water and the anion exchanger is once again available for purifying process medium and/or rinsing medium.

The preconditioning apparatus preferably comprises a further anion exchanger in addition to the first anion exchanger, so that the two anion exchangers can be operated and regenerated alternately.

This leads to continuous output of process medium and/or rinsing medium, as a result of which the deionization plant can be supplied and operated continuously.

Preference is given to the preconditioning apparatus comprising an apparatus for precipitating the complex anions from the process medium or the rinsing medium and also a subsequent separation device.

This represents, in addition to the anion exchanger, a further possible way of protecting the deionization plant against the complex anions which are problematical and damaging for the operation or regeneration of the exchangers present therein. In addition, in the preconditioning apparatus a precipitant (optionally also a flocculent and/or flocculation aid) is added to the process medium and/or the rinsing medium in order to precipitate the interfering complex anions. In the simplest case, this is an agent for shifting the pH into the alkaline range. It can be, for example, sodium hydroxide or milk of lime.

As separation devices, it is possible to employ a variety of methods for separating the solids from the solution. These are, for example, filtration, sedimentation, centrifugation, cyclones or the like.

The device for precipitation and the separation device can also be combined in a joint unit.

Finally, the anion exchanger and the device for the precipitation and the separation device can also be provided in a supplementary fashion.

Preference is given to the rinsing medium from a plurality of rinsing tanks being fed to the preconditioning apparatus.

This allows further lowering of the fresh water requirement and/or a reduction in the installation costs.

The surface treatment plant preferably has a control unit which is configured for operating and regenerating the preconditioning apparatus in such a way that the complex anions go at most in an undamaging concentration into the deionization plant.

The control unit can for this purpose make recourse to various pumps, valves and/or electrical instrumentation.

Another aspect of the invention provides a preconditioning apparatus which is intended to be installed upstream of a deionization plant of a surface treatment plant and is configured for removing complex anions which are formed and/or present in a thin film conversion process of the surface treatment plant from a process medium and/or a rinsing medium.

Such a preconditioning apparatus can be installed in existing surface treatment plants when these are to be changed from a known phosphating process to a thin film conversion process. In this way, the previously used deionization plant can continue to be used.

Another aspect of the invention provides a process for treating process medium from a thin film conversion coating process in a surface treatment plant and/or treating rinsing medium from subsequent rinsing steps, comprising the following steps:
a) Provision of a deionization plant which
   comprises a cation exchanger and a downstream anion exchanger and
   is configured for deionizing the process medium and/or the rinsing medium;
b) Provision of a preconditioning apparatus which is located upstream of the deionization plant a preconditioning apparatus and is configured for removing complex anions which are formed and/or present in the thin film conversion process from the process medium and/or the rinsing medium;
c) Removal of the complex anions from the process medium and/or the rinsing medium.

Such a process allows the process medium and/or the rinsing medium to be treated in the case of a thin film conversion process, too.

Another aspect of the invention provides a surface treatment plant for treating objects, in particular vehicle bodies, comprising
a) a thin film conversion process in which a ceramic thin film is applied to the objects using a process medium,
b) a subsequent rinsing step in which the objects are rinsed with rinsing medium after the thin film conversion process, and
c) a membrane filtration plant which
   is configured for deionizing the process medium and/or the rinsing medium,
      wherein
d) the membrane filtration plant is preceded by a preconditioning apparatus which is configured for removing complex anions which are formed and/or present in the thin film conversion process from the process medium and/or the rinsing medium.

Since the preconditioning apparatus can be installed in a simple manner upstream of an existing deionization plant, the advantages of the preconditioning apparatus can also be carried over to other treatment plants such as a membrane filtration plant, e.g. a reverse osmosis plant.

All the additional features which advantageously further develop a preconditioning apparatus upstream of a deionization plant with ion exchangers, as are indicated in the dependent claims, can preferably also be used in the surface treatment plant modified by means of the membrane filtration plant.

Other advantages and aspects of the present invention will become apparent upon reading the following description of the drawings and detailed description of the invention.

### BRIEF DESCRIPTION OF THE DRAWINGS

Illustrative embodiments of the invention will be described in more detail below with the aid of the drawings. The drawings show:

FIG. 1 a surface treatment plant having a deionization plant and a preconditioning apparatus according to the invention;

FIG. 2 a surface treatment plant having a deionization plant and a preconditioning apparatus according to the invention as per another illustrative embodiment;

FIG. 3 a surface treatment plant having a deionization plant and a preconditioning apparatus according to the invention as per a further illustrative embodiment.

### DESCRIPTION OF PREFERRED EMBODIMENTS

While this invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

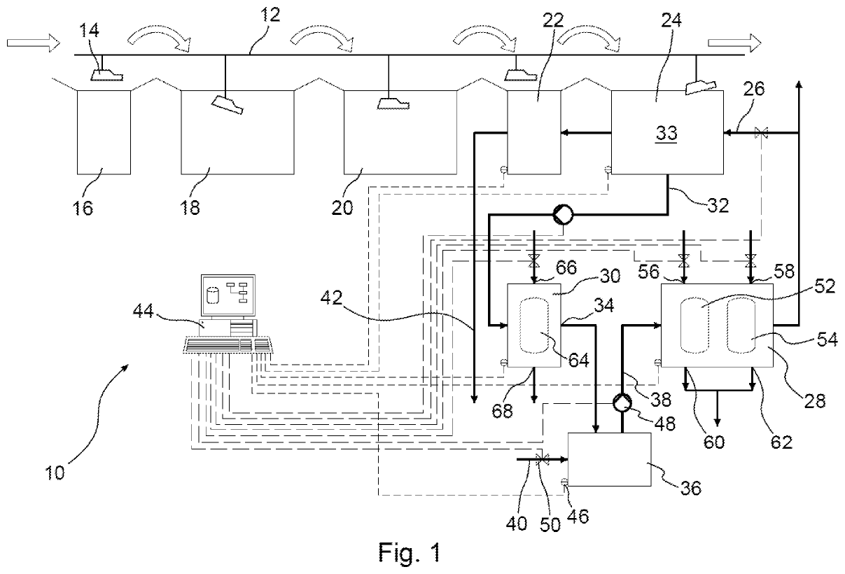

FIG. 1 shows a surface treatment plan denoted overall by 10 having a transport system 12 which conveys objects 14, here in the form of vehicle bodies, through the individual treatment steps of the surface treatment plant.

The extract shown in FIG. 1 from the surface treatment plant comprises firstly two rinsing tanks 16 and 18 which follow a preceding treatment step, for example a cleaning operation.

Furthermore, the surface treatment plant 10 for carrying out a thin film conversion process has a thin film conversion tank 20 which is here configured as dipping tank.

The thin film conversion process is followed by two rinsing steps in the form of a rinsing cascade. For this purpose, a spray rinsing tank 22 which is operated using overflow water from the subsequent rinsing tank 24, which is configured as dipping tank, is arranged downstream of the thin film conversion tank 20. The overflow water can overflow from the rinsing tank 24 into the spray rinsing tank 22 or be actively pumped.

The rinsing tank 24, on the other hand, is supplied with deionized water (DI water) from a conduit 26.

The conduit 26 is in turn supplied by a deionization plant 28 which produces the DI water and is therefore frequently also referred to as DI water plant.

The surface treatment plant 10 additionally comprises a preconditioning apparatus 30.

The preconditioning apparatus 30 is supplied with contaminated rinsing water 33 from the rinsing tank 24 via a discharge conduit 32. An outlet 34 of the preconditioning apparatus 30 is connected to a process water tank 36 from which the deionization plant 28 is in turn supplied via a conduit 38.

The process water tank 36 additionally has a process water feed conduit 40 via which process water from the municipal water supply or spring water can be introduced into the plant.

Finally, a wastewater conduit 42 leads from the spray rinsing tank 22 into a drainage system (not shown) or a physicochemical wastewater treatment plant of the facility.

The surface treatment plant 10 additionally has, as indicated in FIG. 1, a control unit 44 which is configured for monitoring and controlling the processes of the plant via various measurement positions 46, pumps 48 and valves 50.

The deionization plant 28 has a cation exchanger column 52 and an anion exchanger column 54 in its interior. Positively charged ions are replaced by hydrogen ions (H⁺ ions) by means of the cation exchanger column 52. In the downstream anion exchanger column 54, on the other hand, negatively charged ions are replaced by hydroxide ions (OH⁻ ions). Since the corresponding ion exchange materials become exhausted over time, they have to be regenerated from time to time. For this purpose, the deionization plant has a regenerating agent inlet 56 and 58 and also corresponding regenerate outlets 60 and 62 for each column.

In the illustrative embodiment of FIG. 1, the preconditioning apparatus 30 has an anion exchanger column 64 having a selective exchanger material. Here too, a regenerating agent inlet 66 and a regenerate outlet 68 are provided.

The surface treatment plant 10 operates as follows:

In the thin film conversion tank 20, the objects are coated with a nanosize ceramic layer. The chemicals used here comprise compounds of zirconium (Zr), titanium (Ti) and silicon (Si) as fluoride complexes. These are, for example, hexafluorozirconic acid (H₂ZrF₆), hexafluorotitanic acid (H₂TiF₆) and hexafluorosilicic acid (H₂SiF₆) or their readily soluble alkali metal salts and/or ammonium salts. Thin film conversion solutions in the form of (organo)silanes can also be used.

These compounds go by means of entrainment by means of the objects from the thin film conversion process into the two subsequent rinsing tanks 22 and 24.

In the preconditioning apparatus 30, the complex anions from the thin film conversion process which are present in the downflowing rinsing water 33 and comprise zirconium, titanium or silicon are replaced by other anions, with acid anions generally coming into question here. Thus, ion exchange of these complex anions which are problematical for the deionization plant 28 takes place by means of the selective exchanger material in the anion exchange column 64 of the preconditioning apparatus 30.

The acid anions then leave the preconditioning apparatus 30 together with the remaining rinsing water 33 via the conduit 34 and are introduced into the process water tank 36. From there, they go, optionally together with freshly introduced process water to maintain the total amount of liquid in the system of the surface treatment plant 10, into the deionization plant 28.

In the deionization plant 28, the cations are firstly replaced by hydrogen cations and the anions are subsequently replaced by hydroxide anions in a manner known per se, with anions which are unproblematical for the later regeneration being incorporated into the exchanger material of the deionization plant 28 by means of the ion exchange in the preconditioning apparatus 30.

The deionization plant 28 can thus be regenerated in a known way by the cation exchanger column 52 being regenerated under acidic conditions and the anion exchanger column 54 being regenerated under alkaline conditions. Thus, blocking of the ion exchanger material due to precipitation of the complex anions in the alkaline regeneration does not occur in the deionization plant 28.

To regenerate the anion exchanger column 66 of the preconditioning apparatus 30, a regeneration in the acidic or neutral range is carried out instead of an alkaline regeneration. For this purpose, regenerating agents which have a pH of less than 6 are used at the regenerating agent inlet 66 of the ion exchanger column 64. This can be achieved by means of acid ions of strong acids since these do not shift the pH, while acid ions of medium-strength or weak acids would increase the pH, as a result of which the complex anions would precipitate in the anion exchanger column 64 in the preconditioning apparatus 30.

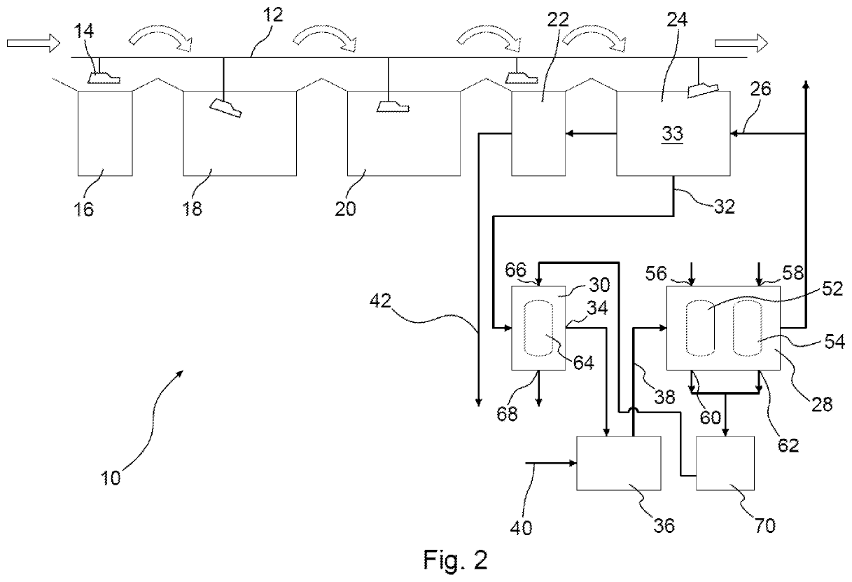

Since, in the illustrative embodiment of FIG. 1, additional regenerate is formed in the preconditioning apparatus 30 compared to the prior art, FIG. 2 shows an illustrative embodiment which is improved in this respect, with components having a similar or identical function being denoted by the same reference numeral.

As can be seen from FIG. 2, the regenerate arising in the deionization plant 28 is fed at least in part as regenerating agent to the preconditioning apparatus 30.

For this purpose, both or only one of the two regenerate outlets 60, 62 of the deionization plant 28 are connected to a regenerate tank 70. The figure does not show a branching-off opportunity in order to discard regenerate instead of conveying it to the regenerate tank 70. The regenerate tank 70 is also joined to the regenerating agent inlet 66 of the preconditioning apparatus 30. This makes it possible to use regenerating agent a number of times and/or to reduce the installation costs.

For example, the cation exchanger column 52 can be regenerated using an excess of hydrochloric acid (HCl) as regenerating agent. In the first runnings of the regenerate, i.e. at the beginning of regeneration, the foreign ions from the cation exchanger column 52 are firstly present in high concentration. These first runnings of the regenerate can be discarded via the branching-off opportunity. The concentration of the foreign ions in the regenerate then decreases and the regenerate is then collected in the regenerate tank 70. However, the regenerate present in the regenerate tank 70 has a somewhat lower acid content, i.e. a somewhat higher pH, compared to the regenerating agent at the inlet.

The anion exchanger column 64 of the preconditioning apparatus 30 is then supplied with this less concentrated hydrochloric acid as regenerating agent.

A further possibility is to reuse the ions which are exchanged with the complex anions in the anion exchanger column 64 (for example Cl⁻ ions) and go via the process water into the deionization plant 28. This is possible because these ions firstly become absorbed in the anion exchanger column 54 during normal operation of the deionization plant 28 and are replaced by OH⁻ ions. During the regeneration, these Cl⁻ ions can be collected in the regenerate tank 70 from where they go back as regenerating agent into the anion exchanger column 64 of the preconditioning apparatus 30. This results in a circuit by means of which the regenerating agent requirement is reduced and, in addition, the process water consumption is decreased further.

However, additional instrumentation is necessary for regenerate monitoring and further introduction possibilities.

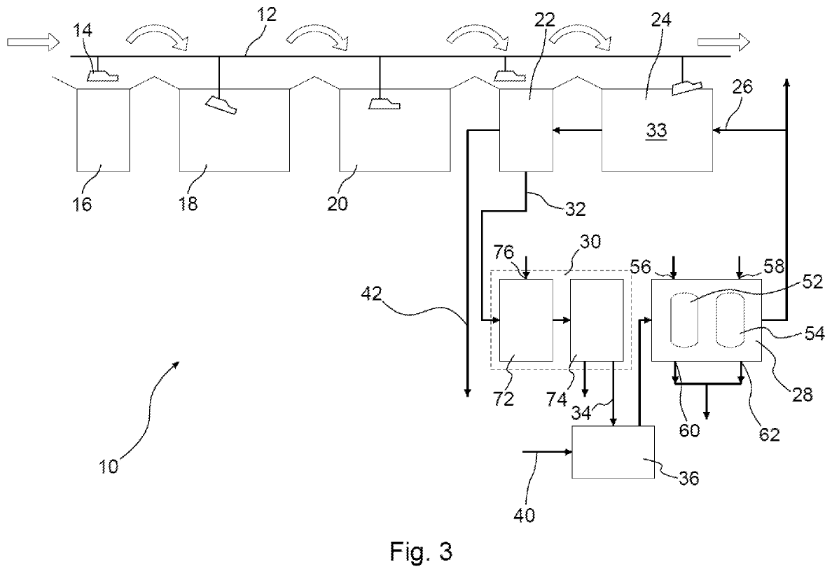

Finally, FIG. 3 shows a further illustrative embodiment in which the preconditioning apparatus 30 comprises a device 72 for precipitating the complex anions and a subsequent separation device 74, for example a sedimentation and/or filtration unit, for separating the precipitated solids off from the aqueous rinsing water 33.

In the case of this illustrative embodiment, the complex anions from the thin film conversion process which are problematical for the deionization plant 28 are precipitated from the rinsing water by addition of appropriate precipitating chemicals at a precipitant inlet 76. For example, the pH can be shifted into the alkaline range. It is also possible to use flocculants which assist flocculation of the solids.

The separation device 74 is connected to the process water tank 36 in which the process water is, as in the preceding illustrative embodiments, collected for further treatment in the deionization plant 28.

As can also be seen from FIG. 3, the rinsing water 33 can also be taken from the spray rinsing tank 22. This applies for all illustrative embodiments.

Depending on the design of the plant, a person skilled in the art is also free to employ combinations of the abovementioned illustrative embodiments.

Thus, it is, for example, conceivable in the illustrative embodiment of FIG. 3 to provide an anion exchanger column 64 corresponding to FIGS. 1 and 2 downstream of the separation device 74 in the preconditioning apparatus 30.

The rinsing water from a plurality of rinsing tanks 22 and 24 can also be combined.

Furthermore, it is in principle conceivable to treat the process medium of the thin film conversion process in a similar manner. This is because it can also be useful for the thin film conversion coating tank 20 for downflowing process medium to be treated and/or disposed of by means of a combination of preconditioning apparatus 30 and a deionization plant 28.

As a modification of the above illustrative embodiments, an activated carbon filter can be used in addition to or as an alternative to a gravel filter as prefilter upstream of the preconditioning apparatus. This can, as adsorptively acting filter, remove, for example, interfering surfactants, biocides and/or disinfectants. Depending on the specific use, an activated carbon filter can be provided especially when the DI water produced is not only to be recirculated to the rinsing process but also to be used in other process sections. An activated carbon filter downstream of the preconditioning apparatus and/or the deionization plant can also be advantageous.

Independently of the subject matter at the time of the invention, it has been recognized that a preconditioning apparatus according to the invention can advantageously also be provided upstream of a membrane filtration plant, e.g. a reverse osmosis plant, in order to remove complex anions. This is because the complex anions described can also cause malfunctions as a result of blocking of the membrane (also known as fouling or scaling). For this reason, water containing the constituents of the thin film conversion has hitherto not been conveyed through membrane filtration plants. Here too, an upstream preconditioning apparatus according to the invention could remove the interfering complex anions, which would make further deionization by means of the membrane filtration plant possible.

In the figures, the deionization plant 28 would then be taken to be a membrane filtration plant 28 having one or more membrane filters 52 and 54.

The applicant reserves the right to pursue these ideas further, for example in the context of subapplications.

In particular, an inventive idea can be regarded generally as removing complex anions from any water from surface treatment plants by means of an anion exchanger whose pH is regulated as described above in the context of a preconditioning step.

While this invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

1. A surface treatment plant for treating objects, comprising:
a) a thin film conversion process in which a ceramic thin film is applied to objects using a process medium,
b) a subsequent rinsing step in which the objects are rinsed with a rinsing medium after the thin film conversion process, and
c) a deionization plant which
comprises a cation exchanger and a downstream anion exchanger and
is configured for deionizing the process medium and/or the rinsing medium,
wherein
d) a preconditioning apparatus which is configured for removing complex anions which are formed and/or present in the thin film conversion process from the process medium and/or the rinsing medium is located upstream of the deionization plant.

2. The surface treatment plant according to claim 1, wherein the preconditioning apparatus comprises an anion exchanger which is configured for replacing the complex anions by other anions.

3. The surface treatment plant according to claim 2, wherein the anion exchanger of the preconditioning apparatus comprises a selective exchanger material.

4. The surface treatment plant according to claim 2, wherein the anion exchanger of the preconditioning apparatus is regenerated using a regenerating agent which has a pH of less than about 6.

5. The surface treatment plant according to claim 2, wherein the preconditioning apparatus comprises a further anion exchanger in addition to the first anion exchanger, so that the two anion exchangers are operated and regenerated alternately.

6. The surface treatment plant according to claim 1, wherein the preconditioning apparatus has a device for precipitating the complex anions from the process medium or the rinsing medium and also a subsequent separation device.

7. The surface treatment plant according to claim 1, wherein the rinsing medium from a plurality of rinsing tanks is fed to the preconditioning apparatus.

8. The surface treatment plant according to claim 1, wherein the surface treatment plant has a control unit which is configured for operating and regenerating the preconditioning apparatus in such a way that the complex anions go at most in an undamaging concentration into the deionization plant.

9. A preconditioning apparatus which is intended to be installed upstream of a deionization plant of a surface treatment plant and is configured for removing complex anions which are formed and/or present in a thin film conversion process of the surface treatment plant from a process medium and/or a rinsing medium.

10. A process for treating process medium from a thin film conversion coating process in a surface treatment plant and/or treating rinsing medium from subsequent rinsing steps, the process comprising the following steps:
a) providing a deionization plant which
comprises a cation exchanger and a downstream anion exchanger and
is configured for deionizing the process medium and/or the rinsing medium;
b) providing a preconditioning apparatus which is located upstream of the deionization plant and is configured for removing complex anions which are formed and/or present in the thin film conversion process from the process medium and/or the rinsing medium;
c) removing complex anions from the process medium and/or the rinsing medium.

11. A Surface treatment plant for treating objects, comprising:
a) a thin film conversion process in which a ceramic thin film is applied to objects using a process medium,
b) a subsequent rinsing step in which the objects are rinsed with a rinsing medium after the thin film conversion process, and
c) a membrane filtration plant which
is configured for deionizing the process medium and/or the rinsing medium,
wherein
d) the membrane filtration plant is preceded by a preconditioning apparatus which is configured for removing complex anions which are formed and/or present in the thin film conversion process from the process medium and/or the rinsing medium.
